(19) United States
(12) Patent Application Publication
(10) Pub. No.: US 2025/0078376 A1
(43) Pub. Date: Mar. 6, 2025

(54) DISPLAY SYSTEM AND DISPLAY METHOD

(71) Applicant: Optoma Corporation, New Taipei City (TW)

(72) Inventor: Jiun-De Lee, New Taipei City (TW)

(73) Assignee: Optoma Corporation, New Taipei City (TW)

(21) Appl. No.: 18/818,616

(22) Filed: Aug. 29, 2024

(30) Foreign Application Priority Data
Sep. 4, 2023 (TW) 112133421

(51) Int. Cl. G06T 13/40; G06F 3/01; G06T 7/70; G06V 40/10; G10L 17/22

(52) U.S. Cl. CPC G06T 13/40; G06F 3/012; G06T 7/70; G06V 40/10; G10L 17/22; G06T 2207/30201

(57) ABSTRACT

A display system and a display method are provided. The display system includes a camera, a display device, and a processor. The camera is used for capturing an image of a target person to generate a captured image. The display device is used for displaying a virtual character. The processor is electrically connected to the camera and the display device. When the target person is located in front of the display device, a visual direction or a moving direction of the virtual character in the display device is toward a position of the target person.

### CROSS-REFERENCE TO RELATED APPLICATION

This application claims the priority benefit of Taiwan application serial no. 112133421, filed on Sep. 4, 2023. The entirety of the above-mentioned patent application is hereby incorporated by reference herein and made a part of this specification.

### BACKGROUND

### Technical Field

The disclosure relates to an electronic device and an operation method, and particularly relates to a display system and a display method.

### Description of Related Art

In conventional display methods of virtual reality, a user must wear a head-mounted virtual reality display device to view virtual reality images, which often causes discomfort to the head or eyes. Moreover, conventional virtual reality control requires an additional sensing device to sense gesture changes or posture changes of the user, which is easy to cause a problem of feedback delay, and the above devices cannot provide the user with a good interactive experience.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The disclosure is directed to a display system and a display method, which are adapted to display functions of interactive virtual characters.

Additional aspects and advantages of the disclosure will be set forth in the description of the techniques disclosed in the disclosure.

In order to achieve one or a portion of or all of the objects or other objects, an embodiment of the disclosure provides a display system including a camera, a display device, and a processor. The camera is configured to capture an image of a target person to generate a plurality of captured images. The display device is configured to display a virtual character. The processor is electrically connected to the camera and the display device. When the target person is located in front of the display device, a sight direction or a moving direction of the virtual character in the display device is toward a position of the target person.

In an embodiment of the disclosure, the processor is configured to analyze the captured images to identify the target person. The display device is configured to display a first image with the virtual character. The processor identifies specific parts of the target person in the plurality of captured images, and adjusts the sight direction or the moving direction of the virtual character in the first image so that the sight direction or the moving direction of the virtual character is toward the position of the target person.

In an embodiment of the disclosure, the specific part is a head of the target person.

In an embodiment of the disclosure, the plurality of captured images include a first reference image and a second reference image. The first reference image is a shooting result of the target person located at a first specified position, and the second reference image is a shooting result of the target person located at a second specified position. The processor calculates to obtain first reference position coordinates of the head of the target person according to the first reference image, and calculates to obtain second reference position coordinates of the head of the target person according to the second reference image. The processor generates position coordinates of the target person according to a coordinate change between the first reference position coordinates and the second reference position coordinates, and adjusts the sight direction or the moving direction of the virtual character in the first image according to the position coordinates of the target person.

In an embodiment of the disclosure, the display system further includes a microphone. The microphone is electrically connected to the processor and configured to obtain target audio data. The processor analyzes the target audio data to identify a voice instruction in the target audio data, and determines an interactive behavior of the virtual character in the first image based on the voice instruction.

In an embodiment of the disclosure, when a number of person images in the plurality of captured images is plural, the processor identifies a plurality of audio data of different tones generated by a plurality of persons and captured by the microphone, so as to select one of the plurality of audio data as the target audio data.

In an embodiment of the disclosure, when a number of person images in the plurality of captured images is plural, the processor selects the target person in the plurality of captured images according to a specified instruction.

In order to achieve one or a portion of or all of the objects or other objects, an embodiment of the disclosure provides a display method including: capturing an image of a target person by a camera to generate a captured image; displaying a virtual character by a display device; and when the target person is located in front of the display device, directing a sight direction or a moving direction of the virtual character in the display device toward a position of the target person.

In an embodiment of the disclosure, the display device is configured to display a first image with the virtual character, and the step of directing the sight direction or the moving direction of the virtual character in the display device toward the position of the target person includes: analyzing the captured image by a processor to identify the target person; identifying a specific part of the target person in the captured image by the processor; and adjusting the sight direction or the moving direction of the virtual character in the first image by the processor, so that the sight direction or the moving direction of the virtual character is toward the position of the target person.

In an embodiment of the disclosure, the specific part is a head of the target person.

In an embodiment of the disclosure, the plurality of captured images include a first reference image and a second reference image. The first reference image is a shooting result of the target person located at a first specified position, and the second reference image is a shooting result of the target person located at a second specified position. The step of adjusting the sight direction or the moving direction of the virtual character in the first image includes: calculating to obtain first reference position coordinates of the head of the target person by the processor according to the first reference image; calculating to obtain second reference position coordinates of the head of the target person by the processor according to the second reference image; generating position coordinates of the target person by the processor according to a coordinate change between the first reference position coordinates and the second reference position coordinates; and adjusting the sight direction or the moving direction of the virtual character in the first image by the processor according to the position coordinates of the target person.

In an embodiment of the disclosure, the step of directing an interactive behavior of the virtual character in the first image toward the specific part of the target person includes: obtaining target audio data by a microphone; analyzing the target audio data by the processor to identify a voice instruction in the target audio data; and determining the interactive behavior of the virtual character in the first image according to the voice instruction by the processor.

In an embodiment of the disclosure, the step of directing the interactive behavior of the virtual character in the first image toward the specific part of the target person includes: when a number of person images in the captured image is plural, identifying a plurality of audio data of different tones generated by a plurality of persons and captured by the microphone by the processor, so as to select one of the plurality of audio data as the target audio data.

In an embodiment of the disclosure, the display method further includes: when a number of person images in the captured image is plural, selecting the target person in the captured image according to a specified instruction by the processor.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a display system according to an embodiment of the disclosure.

FIG. 2 is a flowchart of a display method according to an embodiment of the disclosure.

FIG. 3 is a schematic diagram of a display system according to another embodiment of the disclosure.

FIG. 4A and FIG. 4B are respectively schematic diagrams showing a virtual character according to an embodiment of the disclosure.

FIG. 5A and FIG. 5B are respectively schematic diagrams showing a virtual character according to another embodiment of the disclosure.

FIG. 6A and FIG. 6B are respectively schematic diagrams showing a virtual character according to another embodiment of the disclosure.

FIG. 7A and FIG. 7B are respectively schematic diagrams showing a virtual character according to another embodiment of the disclosure.

### DESCRIPTION OF THE EMBODIMENTS

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

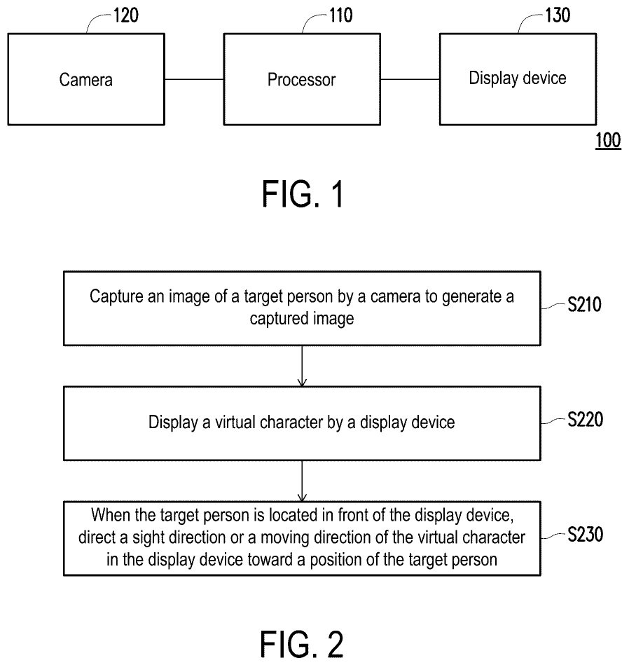

FIG. 1 is a schematic diagram of a display system according to an embodiment of the disclosure. Referring to FIG. 1, a display system 100 includes a processor 110, a camera 120 and a display device 130. The processor 110 is electrically connected to the camera 120 and the display device 130. In the embodiment, the processor 110 may provide display data to the display device 130, and the display device 130 displays a first image 400, where the first image 400 may include a virtual character. The processor 110 may track a position of a viewer (i.e., a following target person) through the camera 120. Namely, the camera 120 captures an image of the target person and generates a plurality of captured images. The processor 110 analyzes coordinates of positions of the target person in the plurality of captured images, and the processor 110 is configured to adjust a sight direction or a moving direction of the virtual character in the first image 400. The virtual character may be an animal with eyes or an object with moving direction in motion. In addition, in an embodiment, the processor 110 and the display device 130 may be integrated into a same electronic device, and the electronic device is electrically connected to the external camera 120 to form the display system 100. Alternatively, in an embodiment, the processor 110, the camera 120 and the display device 130 are integrated into a same electronic device to form the display system 100. It should be noted that the display system 100 of the disclosure is not a head-mounted display device.

In the embodiment, the processor 110 may include, for example, a central processing unit (CPU), a graphics processing unit (GPU), or other programmable general-purpose or special-purpose microprocessor, digital signal processor (DSP), programmable controller, application specific integrated circuits (ASIC), programmable logic device (PLD), other similar processing devices or combinations of these devices.

In the embodiment, the camera 120 may be electrically connected to the processor 110 in a wired or wireless manner.

In the embodiment, the display device 130 may be, for example, a liquid crystal display (LCD), a light emitting diode (LED) display, or an organic light emitting diode (OLED) display or a projector, i.e., a device that may display or project images, which is not limited by the disclosure.

FIG. 2 is a flowchart of a display method according to an embodiment of the disclosure. Referring to FIG. 2, the display system 100 may perform the following steps S210 to S230. In step S210, the display system 100 may capture an image of a target person through the camera 120 to generate a plurality of captured images. The processor 110 may analyze the plurality of captured images to identify coordinates of a position of the target person in the plurality of captured images. In step S220, the display system 100 may display the first image 400 with a virtual character through the display device 130. In step S230, when the target person is located in front of the display device 130 and the camera 120, the display system 100 may direct a sight direction or a moving direction of the virtual character in the display device 130 toward the position of the target person. In the embodiment, when the target person moves in front of the display device 130, the sight direction or the moving direction of the virtual character also moves accordingly, what remains unchanged is that the sight direction or the moving direction of virtual character is still towards the position of the target person. The processor 110 may identify specific parts of the target person in the plurality of captured images, and adjust the sight direction or the moving direction of the virtual character in the first frame 400, so that the sight direction or the moving direction of the virtual character is toward the position of the target person. The specific part may be a head or eyes of the target person.

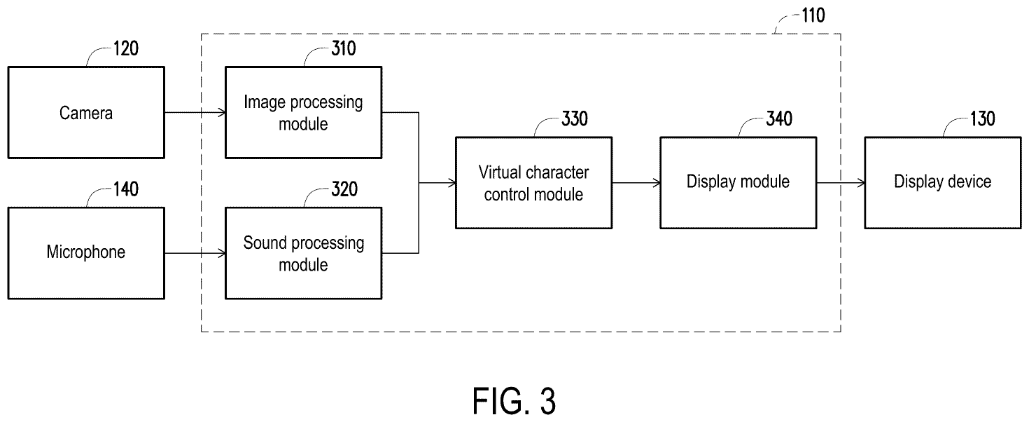

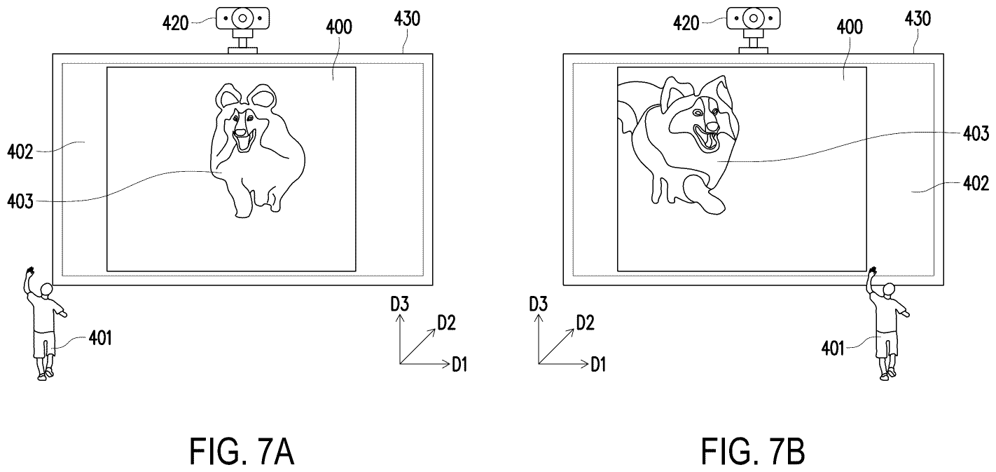

Specifically, referring to FIG. 1, FIG. 3 and FIG. 7A, FIG. 3 is a schematic diagram of a display system according to another embodiment of the disclosure. FIG. 7A is a schematic diagram of a virtual character according to another embodiment of the disclosure. The display system 100 further includes at least one storage device. The processor 110 electronically connects with the at least one storage device (not shown). The storage device may include, for example, a dynamic random access memory (DRAM), a flash memory or a non-volatile random access memory (NVRAM), etc. The storage device may store a plurality of programs, where an image processing module 310, a sound processing module 320, a virtual character control module 330 and a display module 340 are all programs. The processor 110 may execute the image processing module 310, the sound processing module 320, the virtual character control module 330 and the display module 340 as shown in FIG. 3. In the embodiment, the display system 100 may further include a microphone 140, and the microphone 140 is electrically connected to the processor 110. In the embodiment, the image processing module 310 may first obtain a plurality of captured images from the camera 120, where the plurality of captured images are continuous images. The plurality of captured images may include a first reference image and a second reference image. A shooting time of the first reference image is earlier than a shooting time of the second reference image. The first reference image may be a shooting result of the target person located at a first specified position (such as one of front, front right, or front left), and the second reference image is a shooting result of the target person located at a second specified position (such as another one of front, front right, or front left). The processor 110 may use the image processing module 310 to analyze the first reference image and the second reference image to confirm position coordinates of the target person, such as position coordinates of the specific part of the target person. Specifically, the processor 110 may calculate to obtain first reference position coordinates of the head of the target person according to the first reference image, and may calculate to obtain second reference position coordinates of the head of the target person according to the second reference image. The image processing module 310 generates position coordinates of the target person according to a coordinate change between the first reference position coordinates and the second reference position coordinates. The position coordinates of the target person are three-dimensional position coordinates.

The image processing module 310 provides the position coordinates of the target person to the virtual character control module 330 executed by the processor 110, and the virtual character control module 330 may adjust the sight direction or the moving direction of the virtual character in the first image 400 according to the position coordinates of the target person.

Specifically, the virtual character control module 330 converts the position coordinates of the target person located in a coordinate system of the captured image and the coordinates of the virtual character in a coordinate system of the first image to a virtual spatial coordinate system generated by the virtual character control module 330. Since the position coordinates of the target person have depth information, a distance between the target person and the display device may be learned. It is easier to understand that the virtual character control module 330 uses the above-mentioned coordinate conversion technology and a triangulation positioning technology to simulate a viewing angle of the camera to a viewing angle of a virtual character 403 in the first image 400 in the virtual spatial coordinate system, and adjusts feature points of the virtual character to connect with the position coordinates of the target person in a line. For example, the feature points of the virtual character are eyes.

The virtual character control module 330 may adjust the sight direction or the moving direction of the virtual character in the virtual spatial coordinate system based on the head position of the target person in the virtual spatial coordinate system. In this way, the sight direction or the moving direction of the virtual character may be continuously towards the position of the target person, enabling the target person to have a good interactive experience. The virtual character control module 330 transmits the adjusted first image 400 with the virtual character 403 to the display module 340, and through signal conversion of the display module 340, the adjusted first image 400 with the virtual character 403 is displayed on a display surface 402 of the display device 130.

In an embodiment, the target person may also raise his hand or move his position as the position coordinates of the specific part. In this regard, the image processing module 310 may generate the position coordinates of the specific part of the target person by analyzing a posture change of the target person in the captured image. The virtual character control module 330 may also determine the interactive behavior of the virtual character in the first image 400 based on the position coordinates of the specific part of the target person. For example, the target person may raise his hand, and the virtual character may move toward the target person raising his hand or perform other response actions in the first image 400.

In an embodiment, the target person may also make a sound. In this regard, the sound processing module 320 may obtain target audio data of the target person through the microphone 140. The sound processing module 320 may analyze the target audio data to identify a voice instruction in the target audio data (i.e., perform voice recognition), and provide the voice instruction to the virtual character control module 330, and the virtual character control module 330 may determine the interactive behavior of the virtual character in the first image 400 according to the voice instruction. For example, the target person may shout, and the virtual character may move toward the shouting target person or perform other response actions in the first image 400.

In addition, the display system 100 further has an input/output device, and the input and output device is, for example, a remote control, a mouse or a keyboard. When a number of person images in the captured image is plural, the processor 110 may further select the target person in the captured image according to a specified instruction. The specified instruction may, for example, come from the input/output device of the display system 100 and may be set by the target person or other users. Alternatively, in an embodiment, when the number of the person images in the captured image is plural, the processor 110 recognizes a plurality of audio data of different tones generated by a plurality of persons and captured by the microphone 140 to select one of the plurality of audio data as the target audio data. The method of selecting the target audio data may be preset by the system or manually set by the user, which is not limited by the disclosure.

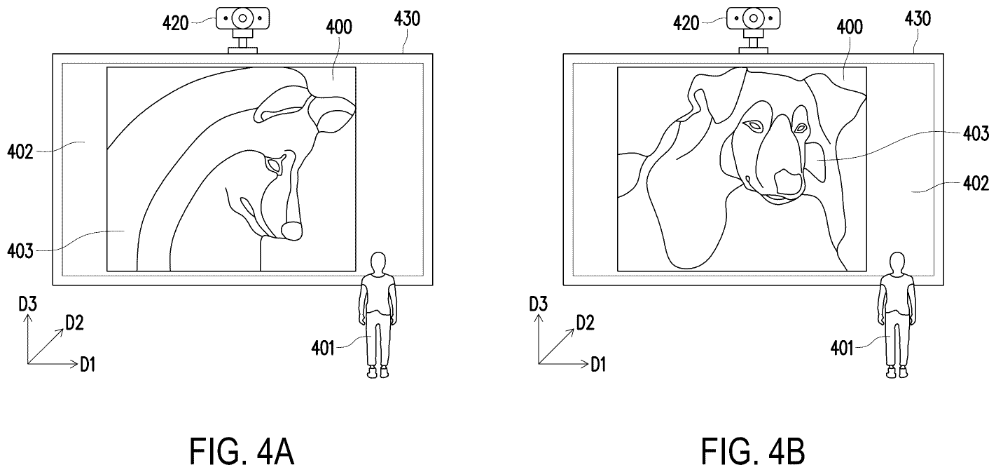

FIG. 4A and FIG. 4B are respectively schematic diagrams showing a virtual character according to an embodiment of the disclosure. Referring to FIG. 4A, a display surface 402 of a display device 430 may be parallel to a plane extending in a direction D1 and a direction D3, and the display device 430 may display an image (i.e., the first image 400) in a direction opposite to a direction D2. A target person 401 may stand at a front left side of the display surface 402 of the display device 430, and the target person 401 may view the virtual character 403 displayed on the display device 430. In this regard, the camera 420 may capture an image of the target person 401 to generate a captured image, and through the above-mentioned program executed by the processor 110, the sight direction of the virtual character 403 as shown in FIG. 4B may be adjusted to be toward the target person 401. In an embodiment of the disclosure, the camera 420 is disposed at an upper middle position of the display device 430.

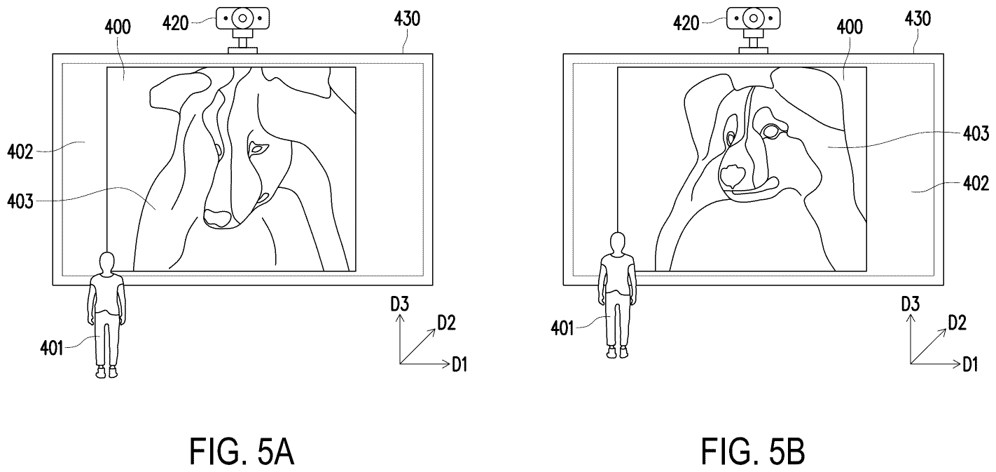

FIG. 5A and FIG. 5B are respectively schematic diagrams showing a virtual character according to another embodiment of the disclosure. Referring to FIG. 5A, the target person 401 may move to the front right side of the display surface 402 of the display device 430, and the target person 401 may view the virtual character 403 displayed on the display device 430. In this regard, the camera 420 may capture an image of the target person 401 to generate a captured image, and through the above-mentioned program executed by the processor 110, the virtual character 403 shown in FIG. 5B may change the sight direction along with the movement of the target person 401, so that the sight direction may be adjusted to be toward the target person 401.

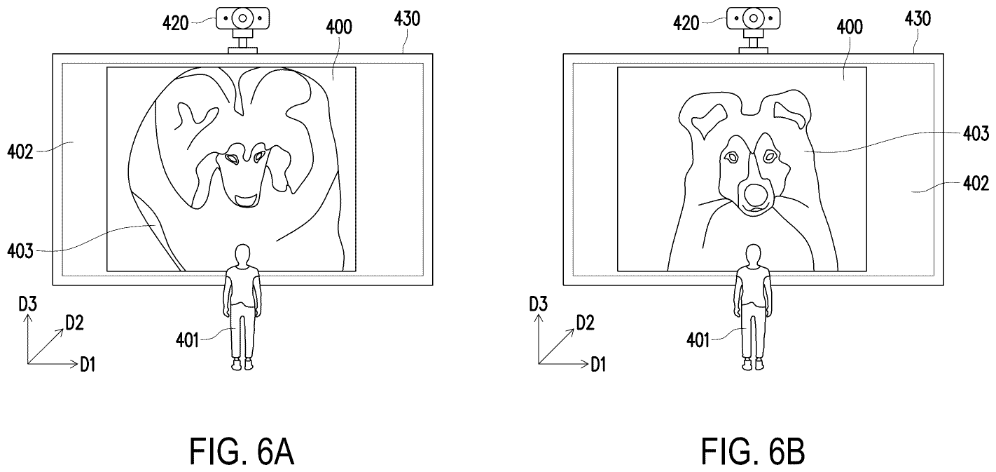

FIG. 6A and FIG. 6B are respectively schematic diagrams showing a virtual character according to another embodiment of the disclosure. Referring to FIG. 6A, the target person 401 may move to the direct front of the display surface 402 of the display device 430, and the target person 401 may view the virtual character 403 displayed on the display device 430. In this regard, the camera 420 may capture an image of the target person 401 to generate a captured image, and through the above-mentioned program executed by the processor 110, the virtual character 403 shown in FIG. 6B may change the sight direction along with the movement of the target person 401, so that the sight direction may be adjusted to be toward the target person 401.

FIG. 7A and FIG. 7B are respectively schematic diagrams showing a virtual character according to another embodiment of the disclosure. Referring to FIG. 7A, the target person 401 may be located at the front right side of the display surface 402 of the display device 430, and the target person 401 may view the virtual character 403 displayed on the display device 430. The target person 401 may, for example, raise a hand, or perform other gestures or posture changes. In this regard, the camera 420 may capture an image of the target person 401 to generate a captured image, and through the above-mentioned program executed by the processor 110, the sight direction or the moving direction of the virtual character 403 is adjusted to be toward the target person 401, and the interactive behavior of the virtual character 403 may be directed toward the target person 401. For example, the target person 401 may view the virtual character 403 running towards him in the first image 400.

Referring to FIG. 7B, the target person 401 may move to the front left side of the display surface 402 of the display device 430, and the target person 401 may view the virtual character 403 displayed on the display device 430. The target person 401 may, for example, raise a hand, or perform other gestures or posture changes. In this regard, the camera 420 may capture an image of the target person 401 to generate a captured image, and through the above-mentioned program executed by the processor 110, the virtual character 403 change the sight direction along with the movement of the target person 401, and the interactive behavior of the virtual character 403 may be directed toward the target person 401. For example, the target person 401 may view the virtual character 403 running towards him in the first image 400.

Based on the FIG. 4A and FIG. 4B, a correction display method of the embodiment may be illustrated, which is applicable to the display system of the disclosure. The processor 110 in the display system 100 further electronically connects with at least one storage device that stores a plurality of images of the virtual character with different sight directions or moving directions, as shown in FIG. 4A and FIG. 4B. During the correction, the display module 340 is used to sequentially display the sight direction of the virtual character 403 of FIG. 4A and the sight direction of the virtual character 403 of FIG. 4B on the display surface 402 of the display device 430, and the user may stand at a position where they believe that the virtual character 403 is looking directly at the user, thereby allowing the user to set the position of the target person 401 through the processor 110.

In summary, the display system and display method of the disclosure may allow the virtual character in the first image to automatically direct the sight direction and the interactive behavior toward the position of the target person, and the target person does not need to wear an additional device to achieve a good interactive experience. In addition, the display system and display method of the disclosure may also be combined with image recognition to determine the posture changes of the target person and/or voice recognition to determine the voice instructions of the target person, so that the virtual character may perform corresponding interactive behaviors. Therefore, the display system and display method of the disclosure may provide a good immersive interactive experience effect.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A display system, comprising:
a camera, configured to capture an image of a target person to generate a captured image;
a display device, configured to display a virtual character; and
a processor, electrically connected to the camera and the display device,
wherein when the target person is located in front of the display device, a sight direction or a moving direction of the virtual character in the display device is toward a position of the target person.

2. The display system as claimed in claim 1, wherein the processor is configured to analyze the captured image to identify the target person, and the display device is configured to display a first image with the virtual character,
wherein the processor is configured to identify a specific part of the target person in the captured image, and adjust the sight direction or the moving direction of the virtual character in the first image so that the sight direction or the moving direction of the virtual character is toward the position of the target person.

3. The display system as claimed in claim 2, wherein the specific part is a head of the target person.

4. The display system as claimed in claim 3, wherein the captured image comprises a first reference image and a second reference image,
wherein the first reference image is a shooting result of the target person located at a first specified position, and the second reference image is a shooting result of the target person located at a second specified position,
wherein according to the first reference image, the processor is configured to calculate to obtain first reference position coordinates of the head of the target person, and according to the second reference image, calculate to obtain second reference position coordinates of the head of the target person,
wherein the processor is configured to generate position coordinates of the target person according to a coordinate change between the first reference position coordinates and the second reference position coordinates, and adjust the sight direction or the moving direction of the virtual character in the first image according to the position coordinates of the target person.

5. The display system as claimed in claim 1, further comprising:
a microphone, electrically connected to the processor and configured to obtain target audio data,
wherein the processor is configured to analyze the target audio data to identify a voice instruction in the target audio data, and determine an interactive behavior of the virtual character in the first image based on the voice instruction.

6. The display system as claimed in claim 5, wherein when a number of person images in the captured image is plural, the processor is configured to identify a plurality of audio data of different tones generated by a plurality of persons and captured by the microphone, so as to select one of the plurality of audio data as the target audio data.

7. The display system as claimed in claim 1, wherein when a number of person images in the captured image is plural, the processor is configured to select the target person in the captured image according to a specified instruction.

8. A display method, comprising:
capturing an image of a target person by a camera to generate a captured image;
displaying a virtual character by a display device; and
when the target person is located in front of the display device, directing a sight direction or a moving direction of the virtual character in the display device toward a position of the target person.

9. The display method as claimed in claim 8, wherein the display device is configured to display a first image with the virtual character, and the step of directing the sight direction or the moving direction of the virtual character in the display device toward the position of the target person comprises:
analyzing the captured image by a processor to identify the target person;
identifying a specific part of the target person in the captured image by the processor; and
adjusting the sight direction or the moving direction of the virtual character in the first image by the processor, so that the sight direction or the moving direction of the virtual character is toward the position of the target person.

10. The display method as claimed in claim 9, wherein the specific part is a head of the target person.

11. The display method as claimed in claim 10, wherein the captured image comprises a first reference image and a second reference image, wherein the first reference image is a shooting result of the target person located at a first specified position, and the second reference image is a shooting result of the target person located at a second specified position, wherein the step of adjusting the sight direction or the moving direction of the virtual character in the first image comprises:
calculating to obtain first reference position coordinates of the head of the target person by the processor according to the first reference image;
calculating to obtain second reference position coordinates of the head of the target person by the processor according to the second reference image;
generating position coordinates of the target person by the processor according to a coordinate change between the first reference position coordinates and the second reference position coordinates; and
adjusting the sight direction or the moving direction of the virtual character in the first image by the processor according to the position coordinates of the target person.

12. The display method as claimed in claim 8, wherein the step of directing an interactive behavior of the virtual character in a first image toward a specific part of the target person comprises:
obtaining target audio data by a microphone;
analyzing the target audio data to identify a voice instruction in the target audio data by a processor; and
determining the interactive behavior of the virtual character in the first image according to the voice instruction by the processor.

13. The display method as claimed in claim 12, wherein the step of directing the interactive behavior of the virtual character in the first image toward the specific part of the target person further comprises:
when a number of person images in the captured image is plural, identifying a plurality of audio data of different tones generated by a plurality of persons and captured by the microphone by the processor, so as to select one of the plurality of audio data as the target audio data.

14. The display method as claimed in claim 8, further comprising:
when a number of person images in the captured image is plural, selecting the target person in the captured image according to a specified instruction by the processor.

15. The display method as claimed in claim 8, further comprising:
storing a plurality of images of the virtual character with different sight directions or moving directions, displaying the sight directions or the moving directions of the virtual character in sequence, and setting the position of the target person.
